(19) United States
(12) Patent Application Publication
(10) Pub. No.: US 2004/0265776 A1
(43) Pub. Date: Dec. 30, 2004

(54) Ultrasonic insert with internal flow channel

(76) Inventors: David W. Tipton, Rolling Meadows, IL (US); Patricia H. Parker, Midlothian, IL (US); Shu Chen, Buffalo Grove, IL (US)

Correspondence Address: WELSH & KATZ, LTD, 120 S RIVERSIDE PLAZA, 22ND FLOOR, CHICAGO, IL, 60606, US

(21) Appl. No.: 10/797,171

(22) Filed: Mar. 10, 2004

Related U.S. Application Data
(60) Provisional application No. 60/454,261, filed on Mar. 13, 2003.

(51) Int. Cl. A61C 3/03

(52) U.S. Cl. 433/119

(57) ABSTRACT

A low flow ultrasonic insert has an internal fluid flow channel which extends between an operative tip geometry and a body portion of insert. The channel terminates at the tip geometry with a fluid flow output. A fluid flow input is provided for the channel in the body portion where a transverse slot intersects the channel.

### CROSS REFERENCE TO RELATED APPLICATION

The benefit of the filing date of Provisional Application No. 60/454,261 entitled “Ultrasonic Scaler with Internal Flow Channel” filed Mar. 13, 2003 is hereby claimed.

### FIELD OF THE INVENTION

The invention pertains to ultrasonic inserts of a type usable for scaling or other types of dental treatments. More particularly, the invention pertains to such inserts which include internally formed fluid flow channels to direct fluid at a vibrating treatment applying tip.

### BACKGROUND OF THE INVENTION

Ultrasconic scalers are used in dental offices for de-briding teeth. Other types of ultrasonic instruments are used for various types of other dental therapies. Unlike manual instruments, these instruments have a treatment applying tip which vibrates at an ultrasonic frequency.

Known ultrasonic scalers usually have a hand piece coupled at one end to a cable which includes a hose to provide a fluid, and conductors to provide electrical energy. The other end of the cable terminates at an electrical generator and a fluid source. One known type of fluid is water. Other types of fluid include antimicrobial medicament or the like, depending on the treatment modality.

One insert has been disclosed and claimed in U.S. Pat. No. 5,775,901 entitled “Insert for Ultrasonic Scaler”, incorporated herein by reference. Another is disclosed in pending utility application Ser. No. 10/346,746 entitled “Ultrasonic Swivel Insert”. That application is also incorporated herein by reference. Both the noted patent and application have been assigned to the assignee hereof.

Known inserts are designed to create a fluid spray at the tip to provide cooling and for washing away fragments or other materials being removed by the insert. It has been recognized, over a period of time, that known scalers often provide excessive amounts of fluid which must be removed from the mouth of the respective patient to enable the process to continue.

There is an outstanding need to be able to provide adequate, but not excessive, levels of fluid to improve patient comfort and to reduce unnecessary waste. Preferably such reduced fluid levels could be provided without complicating the structure of such inserts or substantially increasing the cost thereof.

### BRIEF DESCRIPTION OF THE DRAWING

FIG. 1A is a side elevational view of a connecting body of an ultrasonic insert in accordance with the invention;

FIG. 1B is a top plan view of the body of FIG. 1A;

FIG. 1C is a fragmentary, enlarged view of a portion of the body of FIG. 1A;

FIG. 2A is a side elevational view of the connecting body of FIG. 1 subsequent to further processing;

FIG. 2B is a top plan view of the body of FIG. 2A;

FIG. 2C is a fragmentary, enlarged view of a portion of the body of FIG. 2A;

FIG. 2D is an enlarged fragmentary view of a portion of the tip of the body of FIG. 2A; and

FIG. 2E is a sectional view taken along plane 2E-2E of FIG. 2A;

FIG. 3A is a side elevational view of an alternate connecting body in accordance with the invention;

FIG. 3B is a top plan view of the connecting body of FIG. 3A;

FIG. 3C is a fragmentary, enlarged view of a portion of FIG. 3A;

FIG. 3D is a fragmentary, enlarged view of a portion of the tip of FIG. 3A;

FIG. 3E is a sectional view taken along plane 3E-3E of FIG. 3A;

FIG. 4 is a side elevational view of an ultrasonic insert in accordance with he invention;

FIG. 5 is an enlarged side elevational view of a portion of the insert of FIG. 4;

FIG. 6A is a side elevational view of a connecting body with a flow terminating valve;

FIG. 6B is a bottom plan view of the connecting body of FIG. 6A;

FIG. 6C is an enlarged partial view of a portion of the connecting body of FIG. 6A;

FIG. 7 is a side elevational view of an alternate form of a flow stopping valve in a connecting body in accordance with the invention;

FIG. 8A is a side elevational view of a connecting body in accordance with the invention incorporating a spray pattern defining identation; and

FIG. 8B is a bottom plan view of the insert of FIG. 8A.

### DETAILED DESCRIPTION OF THE INVENTION

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

In accordance with the invention, a relatively low flow ultrasonic insert has an elongated body with first and second spaced apart ends. The first end carries a treatment applying tip geometry. The second end is coupled to an ultrasonic transducer. In a preferred embodiment, the tip geometry is integrally formed with the body.

An internal flow channel extends from an opening on the tip geometry back into the body, at an angle to an axis of the body. The channel terminates at a closed surface in the body.

A transverse slot, formed in the body, intersects the flow channel, generally perpendicular thereto. The slot forms a fluid inlet port into the channel. The opening on the tip geometry is a fluid outlet port.

The slot has a predetermined depth and-width. The depth and width parameters alter the size of the fluid inlet port. The size of the fluid inlet port affects the fluid flow rate to the opening on the tip. Other than as set forth herein, all dimensions are in inches.

Slot widths in a range of 0.013 to 0.015 and depths in a range of 0.018 to 0.020 result in relatively low flow rates of fluid at the tip opening. A preferred combination of width and depth is on the order of 0.014 (width) and 0.019 (depth).

The above can result in flow rates of less than 25 cc/min. Those of skill will understand that the applied fluid pressure, usually from a remote fluid source, alters flow rate. Applied pressure might fall in a range on the order of 2-8 psi. Preferably the above slot and channel dimensions will be used with a range of fluid pressure on the order of 3-5 psi to produce the described low flow rate of 25 cc/min or less.

Fluid flows, resulting from the above parameter combinations, provide lower volumes of fluid flow to the tip geometry. These lower volumes are beneficial, when directed against a vibrating tip geometry, in that a patient receives less fluid orally than is the case with known ultrasonic inserts. This means there is less fluid to suction from the patient's mouth during treatment.

In one embodiment, a biased valve can be installed in the flow channel. Fluid pressure opens the valve to provide fluid to the tip. A drop in fluid pressure for example, due to a halt in treatment, results in the valve automatically closing. As a result, fluid after-flow is substantially reduced. Thus, the tip geometry will not drip when the fluid pressure is terminated, for example, when ultrasonic vibrations cease.

An elastomeric or resin valve can incorporate an integrally formed valve closing spring. Alternately, a separate spring can be used.

The tip opening can be shaped to form a predetermined fluid spray pattern. The opening can be elongated or non-circular. Alternately, the tip geometry can be grooved or indented. The grooves or indentations can also shape the spray pattern.

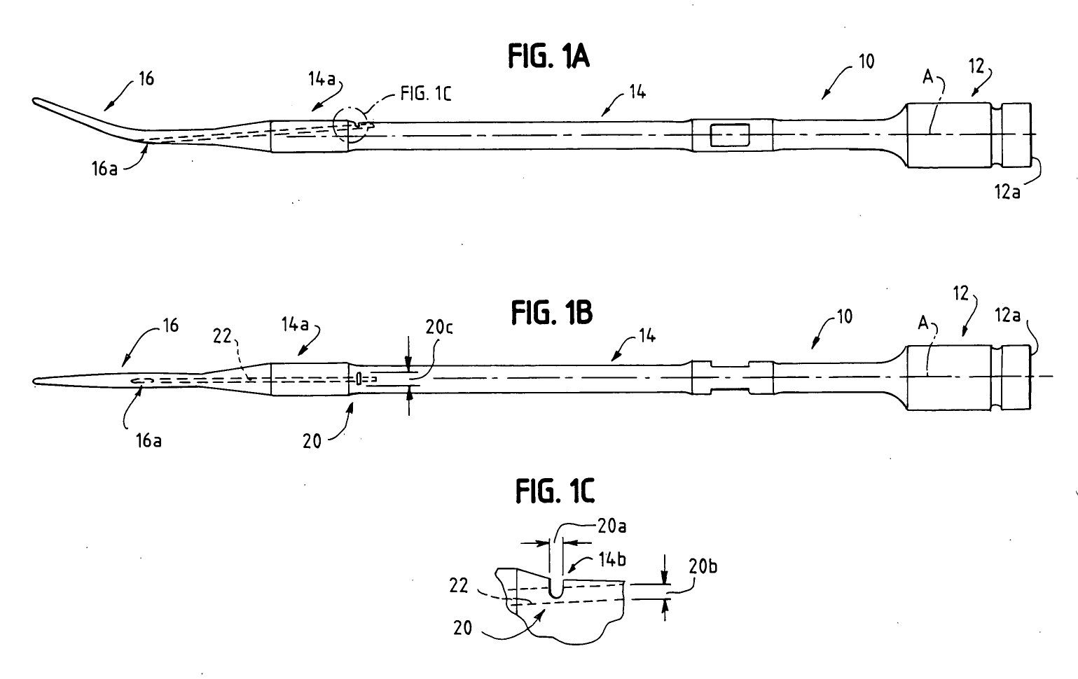

FIGS. 1A and B illustrate respectively side elevational and top plan views of an integrally formed connecting body 10 which can be incorporated into an ultrasonic dental insert. The connecting body 10 includes an enlarged proximal end region 12 which tapers to a substantially constant diameter midsection 14 which in turn terminates at a tapered tip geometry, or, region 16.

Those of skill will understand that the connecting body can have a variety of different dimensions and configuration variations based on, in part, whether the driving frequency is 25,000 Hz or 30,000 Hz. It will also be understood by those of skill in the art that other excitation frequencies could be used, depending on the exact parameters of the connecting body 10, and/or the type of transducer used to produce the mechanical vibrations without departing from the spirit and scope of the present invention.

The illustrated connecting body 10 is merely exemplary and illustrative of the best mode of practicing the invention. The invention is not limited thereto.

The connecting body 10 can be formed extending linearly along a central axis A. The tip region or geometry 16 can be bent, as discussed below to complete the body.

FIGS. 1A and 1B illustrate initial phases of processing of the connecting body 10 with the tip region 16 having previously been bent to an angle on the order of 20° relative to an axis of symmetry A of the body 10. Either before or after the tip region16 is bent, as illustrated in FIGS. 1A, 1B, a lateral slot 20 is cut in the perimeter of the central region 14, best seen in FIG. 1C, transverse, on the order of 90°, to the axis A.

Slot 20 can be formed using any convenient metal forming technology, such as by milling, or the like or by means of electrical discharge machining. The exact way in which the slot 20 is formed is not a limitation of the invention. It will also be understood that the slot 20 has a width parameter 20a, a depth parameter 20b, and a length 20c, the values of which can be varied, as will be explained subsequently, to alter a fluid flow rate of the connecting body 10.

Body 10 includes a fluid flow path 22 which extends from an outlet port 16a in tip region 16 at a selected angle relative to the axis A, on the order of 3°. The passage way 22 extends from outlet port 16a at the preselected angle through section 14a in the central region 14. Passageway 20 terminates at a surface internal to section 14. A fluid inlet port 14b is formed where channel 22 intersects the slot 20, best seen in FIG. 1C.

The fluid flow path 22 can be formed using electrical discharge machining starting from outflow port 16a and then forming a channel that extends toward and past the laterally directed slot 20. If desired, other types of machining could be used to form the fluid flow pathway 22 without departing from the spirit and scope of the present invention.

Those of skill will understand that by varying the width and depth of the laterally direct slot 20 as well as the diameter of the fluid flow pathway 22 the flow rate of fluid to the tip region 16 and out flow port 16a, can be set to a predetermined value. The connecting body 10 provides very precise flow rate control necessary for a relatively low flow type of ultrasonic insert.

For example, the width 20a of the slot 20 can vary in a range of 0.013 to 0.015. Similarly, the depth 20b of the slot 20 can vary in a range of 0.018 to 0.020. Finally, the diameter of the flow channel 22 can vary in a range of 0.012 to 0.016.

As those of skill in the art will understand, the proximal region 12 carries a surface 12a which can be coupled to an adjacent end of an ultrasonic transducer. For example, an end of a magnetostrictive transducer stack of a known type can be attached thereto.

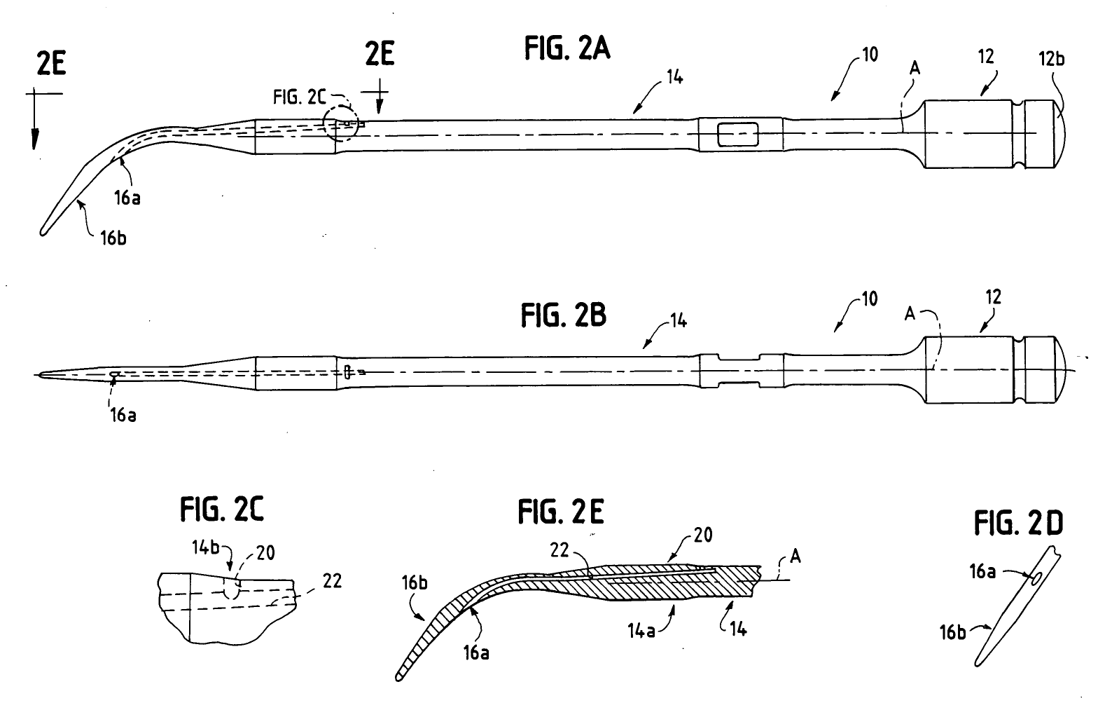

FIGS. 2A and 2B are respectively a side elevational view and a top plan view of the connecting body 10 with the tip region 16 bent from the position illustrated in FIG. 1A to alignment with the central axis A and then further bent to a thereapeutic treatment applying shape with the fluid outflow port 16a located on a concave side of the tip region 16. With the geometry illustrated in FIGS. 2A, 2B, fluid flowing into slot 20, through flow channel 22 and then out the outlet port 16a under pressure will interact with the vibrating tip region 16 to produce a mist or spray in the vicinity of the distal end 16b which will both cool and wash the tooth surfaces being treated. However, the quantities of fluid delivered from the connecting body 10, due to the configuration of the slot 20 and channel 22 will result in lower volumes of fluid entering the patient's mouth both improving patient comfort and also general treatment efficiency.

Those of skill in the art will understand that silver 12b can be braised onto the proximal end surface 12a of the connecting body 10 for purposes of subsequently attaching an adjacent end of the magnetostrictive transducer thereto.

It will also be understood that the fluid outlet port 16a, formed as illustrated in FIG. 1A, 1B, is not round, but is elongated. The outlet port 16a, as discussed subsequently, can be shaped so as to tailor the shape of the mist established in the vicinity of the distal end region 16b.

In the implementation of FIGS. 1A-C, 2A-C, connecting body 10 can be caused to vibrate at a 25 KHz rate. Inserts with the above described types of flow channels can be made to vibrate at different frequencies, for example 30 KHz.

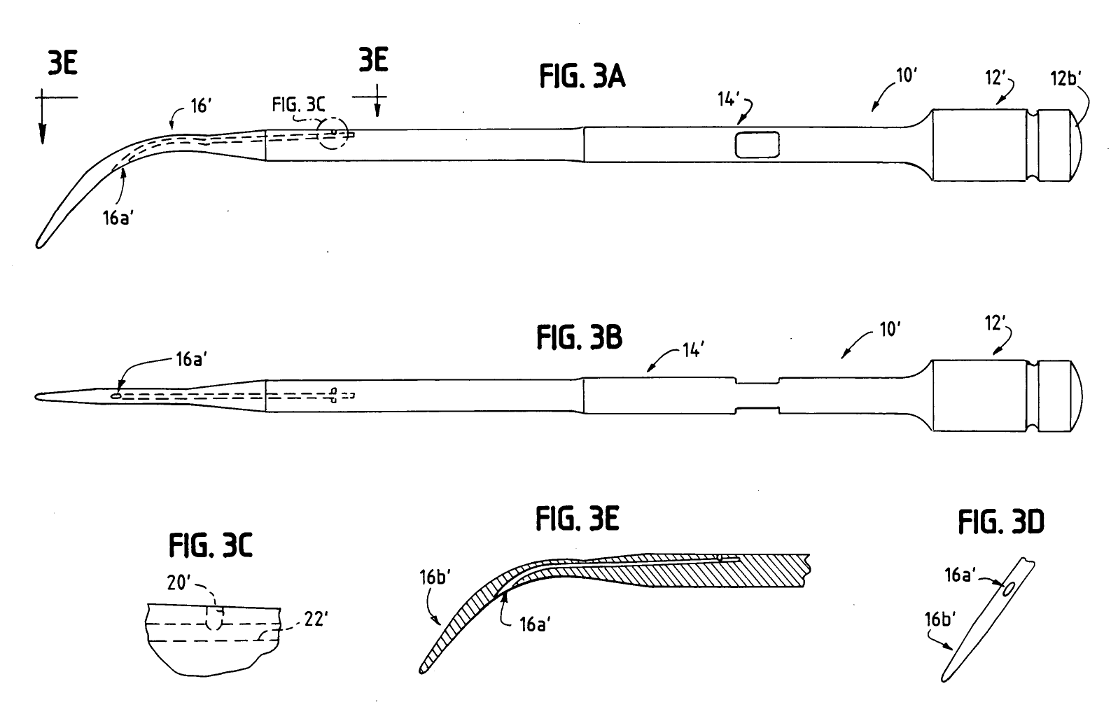

FIGS. 3A, B are respectively side elevational and top plan views of a 30 KHz connecting body 10′. As will be understood by those of skill in the art, the cross-section and parameters of a 30 KHz body, as in FIGS. 3A, B, differ from a body 10, as in FIGS. 2A, B which can be vibrated by a 25 KHz signal.

Body 10′ has a central region 14′ configured for 30 KHz operation. An internal flow channel 22′ as discussed above relative to channel 22, extends from outlet port 16a′ to a laterally oriented slot 20′ formed in the tip geometry 16′ and distal end of body section 14′. Outlet port 16a′ is elongated. A magnetostrictive transducer can be brazed to proximal end 12′ as those of skill in the art will understand.

FIG. 4 is a side elevational view of an ultrasonic insert 30 which incorporates body section 10′ and is energizable for example at 30 KHz. The insert 30 includes a two part rotary bearing 32a, 32b which is locked to the body 10′ by a torque lock 34. The bearing section 32b carries a cylindrical, exterior, elastomeric gripping element 36. A distal end of the insert 30 is closed with end section 38.

A proximal end 12a′ of the insert 30 carries affixed thereto a magnetostrictive ultrasonic transducer 40 of a known type.

The bearing portion 32a can be rotated relative to bearing portion 32b, body 10′, tip 16 and transducer 40. The bearing section 32a can slidably, and releasibly engage an interior surface of a hollow handle portion H, shown in phantom.

As those of skill in the art will understand the handle portion H can carry a cable with electrical conductors and a fluid conduit to couple electrical energy to the insert 30 as well as pressurized fluid. The fluid can flow, via port 42 into the insert 30 through the bearing portion 32b and into the inlet port formed by the intersection of laterally directed spot 20′ and fluid flow channel 22′. Fluid then flows through pathway 22 and out outlet port 16a. The subsequent mist formed by the vibration of the working portion 16b of the tip geometry 16 cools the treatment area and provides a source of fluid for washing away removed particulate matter and the like.

As those of skill in the art will understand, the two part bearing 32a, 32b enables the user to rotate tip geometry 16 relative to the handle H with the torque applied only to the elastomeric gripping portion 36.

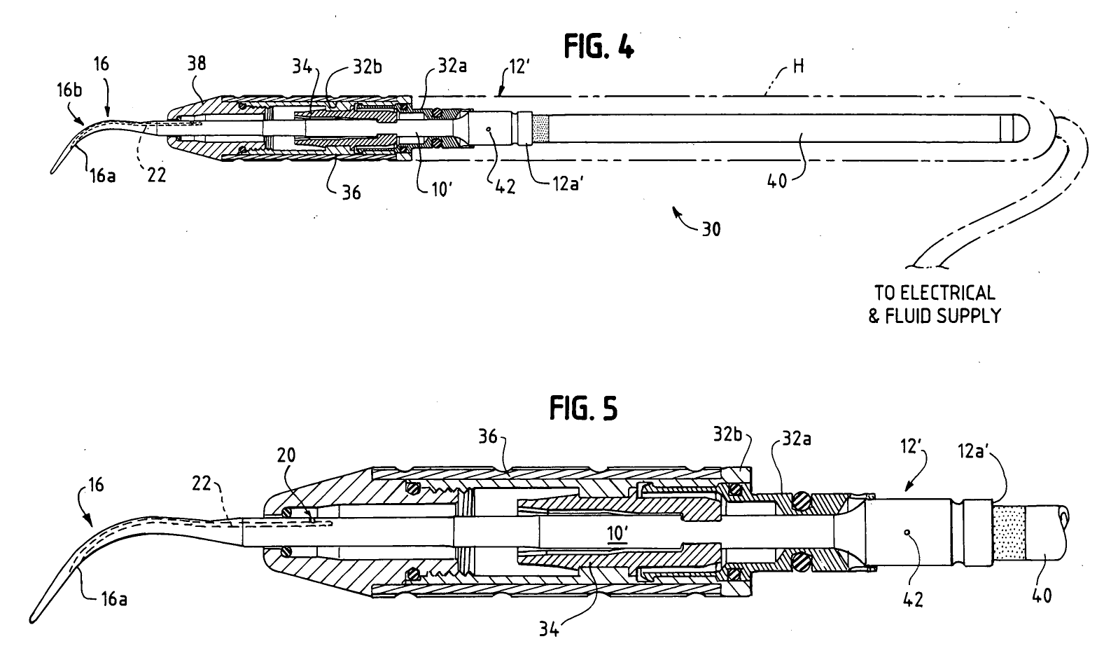

FIG. 5 is an enlarged, side elevational view of a portion of FIG. 4 illustrates additional details of the above noted structural elements.

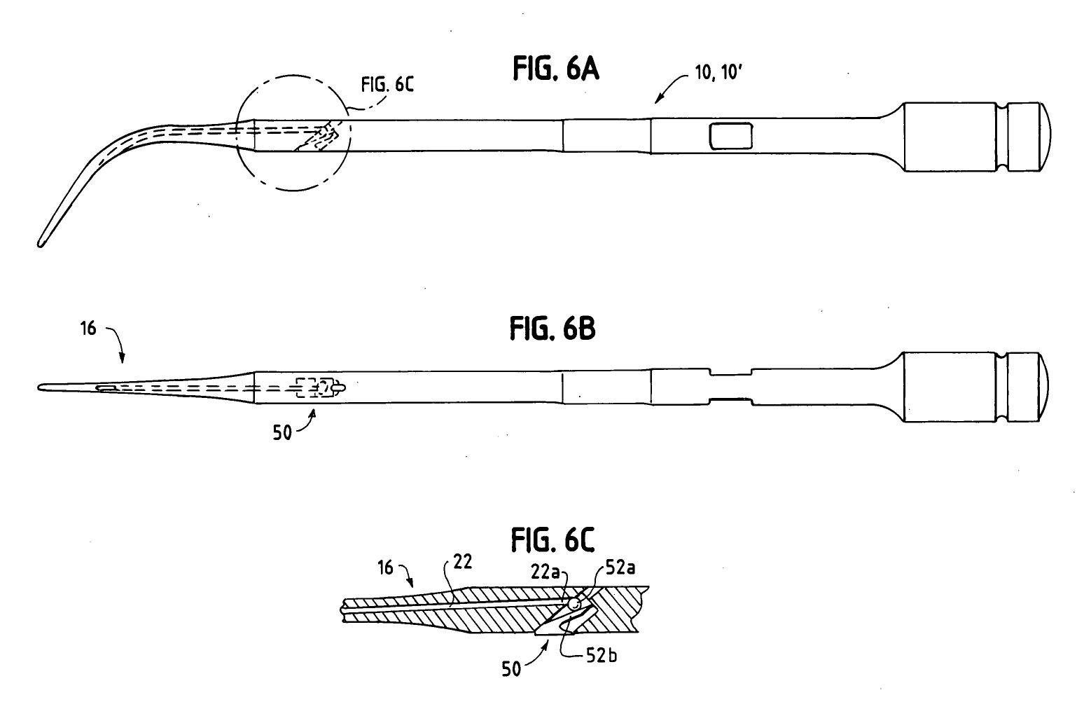

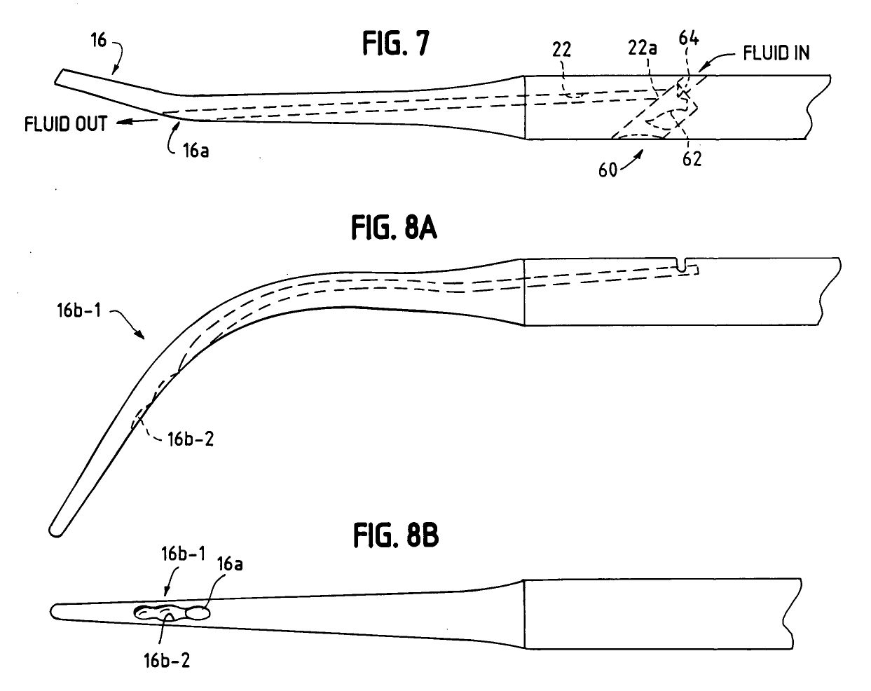

The various views of FIGS. 6 and 7 illustrate two variations of flow stopping valves 50, 60. The valves significantly reduce after-flow from the outlet port 16a once ultrasonic activation has been terminated. The water pressure flowing through the insert, such as the insert 30, opens the respective valves. The valve recloses when the fluid pressure drops.

FIG. 6A, B, C, illustrate embodiments of a flow stopping valve 50 positioned in a body, such as the bodies 10 or 10′ discussed previously. The flow stopping valve 50 incorporates a flow path closing ball 52a which is carried on a silicon flap-type spring 52b.

The valve 50 is located at a proximal end of the flow channel 22. When the fluid pressure is increased, at the same time as the transducer 40 is activated, that pressure deflects silicon flap spring 52b such that ball 52a moves away from a proximal end 22a of flow channel 22 thereby permitting flow therethrough to tip outlet port 16a. Upon a reduction of fluid pressure, the ball 52a and flap spring 52b reclose the inlet port 22a into the flow channel 22 thereby halting further flow of fluid from the outlet port 16a enhancing patient comfort and convenience.

FIG. 7 illustrates an alternate embodiment of a shut-off valve 60 of a type usable in body 10, 10′ discussed previously. The valve 60 incorporates a deflectable silicon member 62 with a v-shaped proximal end 64. Fluid pressure on the v-shaped end 64 deflects the member 62 away from input port 22a of flow channel 22. When the fluid flow from the handle H is terminated, valve portion 62 recloses inflow port 22a thereby stopping any further fluid flow from the port 16a.

FIGS. 8A and 8B illustrate tip region 16b-1 with a shaped indented section 16b-2 for purposes of providing a predetermined, controlled spray pattern. Various shapes and indentations as alternates to the illustrated indentation 16b-2 can be provided to achieve different spray patterns. Such variations all come within the spirit and scope of the present invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. An ultrasonic insert comprising:
an elongated body having first and second body ends and a central axis;
a treatment applying tip region coupled to the first end, the tip region having a tip end displaced from the first end;
a transducer coupled to the second end;
an internal fluid flow channel formed at least in part in the body, extending at an angle to the central axis and having first and second fluid flow ends with one flow end located on the body between the first and second body ends with the other flow end located closer to the tip end than is the one flow end; and
a transverse channel formed in the body adjacent to the one flow end and which intersects the flow channel.

2. An insert as in claim 1 where the other flow end is located on the tip region between the first body and the tip end.

3. An insert as in claim 2 where the other flow end comprises an elongated opening.

4. An insert as in claim 1 which includes one of a piezoelectric or a magnetostrictive transducer coupled to the second end.

5. An insert as in claim 1 where the transverse channel intersects an external periphery of the body and is off-set from the one flow end.

6. An insert as in claim 5 with the second fluid flow end formed in the tip region.

7. An insert as in claim 5 where the transverse channel has a width parameter and a depth parameter, at least one of the parameters selected to establish a selected, fluid flow rate from the other flow end in the presence of a predetermined fluid pressure.

8. An insert as in claim 7 where the depth parameter is in a range of 0.018 to 0.020 inches.

9. An insert as in claim 7 where the width parameter is in a range of 0.013 to 0.015 inches.

10. An insert as in claim 1 where the other flow end comprises a spray controlling indentation formed in an exterior surface of the tip region.

11. An insert as in claim 1 which includes a flow shut off valve, carried on the body, to terminate flow from the tip region in response to a selected condition.

12. An insert as in claim 1 which carries a rotary bearing coupled to the body.

13. An insert as in claim 7 which carries a rotary bearing coupled to the body.

14. An insert as in claim 1 which carries an elastomeric handle.

15. An insert as in claim 12 which carries an elastomeric handle, at least in part adjacent to the bearing.

16. An insert as in claim 13 which carries an elastomeric handle, at least in part adjacent to the bearing.

17. An insert as in claim 15 where the bearing has first and second bearing parts rotatable relative to one another, the handle and tip region are rotatable together relative to one of the bearing parts.

18. An insert as in claim 16 where the bearing has first and second bearing parts rotatable relative to one another, the handle and tip region are rotatable together relative to one of the bearing parts.

19. An insert as in claim 17 which carries a fluid shut off responsive to low fluid flow.

20. An insert as in claim 19 which includes at least one indentation on the tip region for control of a spray pattern.

21. A dental treatment applying apparatus comprising:
a handle that carries an ultrasonic transducer;
a vibrating treatment applying tip portion coupled to the transducer, an internal flow channel is formed at last in part in a portion thereof, the channel having at least first and second sections that intersect to form a fluid inlet into the channel of a size to provide a flow rate less than 25 cc/min with fluid pressure in a selected range with fluid pressure in a selected range.

22. An apparatus as in claim 21 where the sections are substantially perpendicular to one another.

23. An apparatus as in claim 22 where one section terminates at a fluid flow output port in the tip portion.

24. An apparatus as in claim 21 where the tip portion and transducer are removably coupled to the handle.

25. An apparatus as in claim 24 with an elongated body member between the transducer and the tip portion.

26. An apparatus as in claim 25 where one section extends from the tip portion to the body member with the second section intersecting the first section in the body member.

27. An apparatus as in claim 26 where the intersection of the sections defines a fluid inlet port for one of the sections.

28. An apparatus as in claim 27 which includes a two part rotary bearing with one part fixedly coupled to the body and the other part rotatable relative thereto.

29. An apparatus as in claim 28 where the other part slidable engages the handle with the tip portion rotatable relative thereto.

30. An apparatus as in claim 27 where the body member includes a pressure responsive fluid shut off valve.

31. An ultrasonic insert comprising:
a body portion having first and second spaced apart ends and an integrally formed tip section, the tip section is carried by the body portion adjacent to one of the ends, and an internal fluid flow channel which extends between the body and the tip section, with a transverse slot formed in the body which intersects a body-end of the channel forming a fluid input to the channel, the channel terminating at a fluid flow output on the tip section.

32. An insert as in claim 31 which includes an ultrasonic transducer coupled to the other end.

33. An insert as in claim 31 which includes a restricted fluid input which limits fluid output at the tip section to less than 25 cc/min with an applied fluid pressure in a selected range.

34. An insert as in claim 31 where the tip section defines a fluid spray shaping region adjacent to the output.

35. An insert as in claim 31 where the body section includes a pressure responsive flow shut off valve.

36. An insert as in claim 31 which carries a rotary bearing on the body portion.

37. An insert as in claim 33 where the selected range is in the order of 2.5-5.5 psi.

38. A low flow ultrasonic insert comprising:
a body having first and second ends and a central axis, one end terminates in a selected tip region, the other end terminates at an ultrasonic transducer, a lateral slot is formed in the body, the lateral slot intersects a generally axially oriented channel formed in part in the body that extends to and terminates at the tip region, the channel extends at an angle to the axis, the channel terminates within the body proximate to the lateral slot, the intersection of the slot and the channel forms a fluid inflow port, the channel termination at the tip geometry forms a fluid outflow port providing a fluid flow output rate less than 25 cc/minute, with a fluid pressure in a range of 3-5 psi.

39. An insert as in claim 38 where the slot has a width in a range of 0.011 to 0.17 inches.

40. An insert as in claim 38 where the slot has a depth parameter in a range of 0.016 to 0.022 inches.

41. An insert as in claim 39 where the slot has a depth parameter in a range of 0.016 to 0.022 inches.

42. An insert as in claim 38 where the channel has a diameter in a range on the order of 0.010 to 0.018 inches.

43. An insert as in claim 41 where the channel has a diameter in a range on the order of 0.010 to 0.018 inches.

44. An insert as in claim 38 which carries a rotary bearing with the tip region rotatable relative to a selected region of the bearing.

45. An insert as in claim 43 which carries a rotary bearing with the tip region rotatable relative to a selected region of the bearing.
